(19) United States
(12) Patent Application Publication
(10) Pub. No.: US 2026/0125898 A1
(43) Pub. Date: May 7, 2026

(54) Fire Supression Assembly and a Support for Use in a Fire Supression Assembly

(71) Applicant: Castleforms Ltd, Portaloise (IE)

(72) Inventor: Tom Maher, JR., Portaloise (IE)

(21) Appl. No.: 19/376,372

(22) Filed: Oct. 31, 2025

(30) Foreign Application Priority Data
Nov. 6, 2024 (GB) GB2416330.5

(51) Int. Cl. E04B 1/94; E04B 2/30

(52) U.S. Cl. CPC E04B 1/94; E04B 2/30

(57) ABSTRACT

A support for a fire suppression assembly of a building wall. The support has a spanning member which is sized to span between first and second wall elements to define a concrete receiving cavity therebetween. The support has at least one retaining member associated with the spanning member, the at least one retaining member being sized and dimensioned to retain a portion of fire suppression material relative to the support such that said portion of fire suppression material may form at least a portion of at least one of said first and second wall elements.

### PRIORITY OF INVENTION

This Application claims priority to UK Patent Application No. GB2416330.5, filed 6 November 2024.

### FIELD OF THE INVENTION

This invention relates to a fire suppression assembly and a support for use in a fire suppression assembly, and in particular to a fire suppression assembly and support for preventing fire propagating within building walls.

### BACKGROUND OF THE INVENTION

As has been well publicised in recent times as a result of the tragedy at the Grenfell tower in London, elements used to insulate or form part of building wall structures can greatly contribute to spread of fire as said fire can travel across floor structures via flammable wall elements. For example, should a fire start on the ground floor of a building, the fire can propagate through the wall section and to the first floor, where it may cause more destruction.

Current efforts to prevent such spread of fire involves the application of metallic material or flashing at the relevant junctions to prevent travel of fire thereacross. However, application of such elements is time consuming, labour intensive, and can be costly.

It is desirable to provide a fire suppression assembly and support therefore that permits walls to be formed which supress travel of fire at critical junctures within a building and negates or limits the need for additional fire suppression material to be added after initial wall formation.

### SUMMARY OF THE INVENTION

According to the invention there is provided a support for a fire suppression assembly of a building wall, the support comprising: a spanning member configured to span between first and second wall elements to define a concrete receiving cavity therebetween; wherein the support comprises at least one retaining member associated with the spanning member, the at least one retaining member being configured to retain a portion of fire suppression material relative to the support such that said portion of fire suppression material may form at least a portion of at least one of said first and second wall elements.

Advantageously, at least one portion of fire suppression material may be retained relative to the support and form part of the resulting wall structure once the concrete receiving cavity is filled with concrete, thus providing at least a section of wall across which fire is supressed from spreading.

Ideally, the wall elements are wall forming portions which act to form the concrete forming cavity to retain concrete once pumped, poured or therwise placed thereinto, and provide insulative and/or fire suppression properties on the external surfaces of the concrete once set.

Preferably, the support further comprises first and second wall element engagement portions for engaging with respective first and second wall elements.

Ideally, the first and second wall engagement portions each comprise an upper wall element engagement portion for engaging with upper sections of the first and second wall elements.

Preferably, the first and second wall engagement portions each comprise a lower wall element engagement portion for engaging with upper sections of the first and second wall elements.

Ideally, the wall engagement portions are located in four quadrants of the support.

Ideally, the at least one retaining member forms any number of the wall element engagement portions.

Preferably, one, all, or any number therebetween of the wall engagement portions can be utilised to retain fire suppression material.

Preferably, and any wall engagement portions not formed by retaining members are configured to engage with wall forming panels such as Expanded Polystyrene (EPS) panels or the like.

Advantageously, a portion of wall may be created which comprises fire suppression material forming all sections of its wall elements, or may have a mixture of wall elements, at least one comprising fire suppression material and the remainder comprising Expanded Polystyrene (EPS) panels or the like.

Ideally, the at least one retaining member comprises at least one retaining flange or bracket, the fire suppression material being retained by said flange or bracket.

Preferably, the flange or bracket comprises at least one generally horizontal projection.

Ideally, the at least one generally horizontal projection comprises at least one generally vertical projection extending therefrom.

Preferably, the generally horizontal projection inhibits or prevents fire suppression material from moving vertically.

Ideally, the generally vertical projection inhibits or prevents the fire suppression material from moving horizontally.

Preferably, at least the first and/or second wall engagement portion comprises at least one retaining member, the at least one retaining member comprising a generally horizontal projection extending from the spanning member.

Ideally, the generally horizontal projection is located generally centrally in the vertical dimension of the spanning member.

Preferably, the generally horizontal projection comprises an upwardly depending vertical projection extending from its end distal the end which is proximal the spanning member to form a first retaining member with the generally horizontal projection and/or a downwardly depending vertical projection extending from its end distal the end which is proximal the spanning member to form a second retaining member with the generally horizontal projection.

Advantageously, the at least one retaining member may retain fire suppression material to form the upper and/or lower sections of the first wall element.

Optionally, the first wall engagement portion comprises the at least one retaining member.

Optionally, the second wall engagement portion comprises the at least one retaining member.

Alternatively, both the first and second wall engagement portions comprise the at least one retaining member.

Optionally, two retaining members are co-located on a common generally horizontal projection, an upper surface of the common generally horizontal projection having an upper section of fire suppression material engagable therewith and a lower surface of the common generally horizontal projection having a lower section of fire suppression material engagable therewith.

Preferably, the common generally horizontal projection is located generally centrally in the vertical dimension of the spanning member.

Ideally, the common generally horizontal projection comprises a generally vertical flange extending across its end distal the end which is proximal the spanning member, the generally vertical flange having a first generally vertical portion extending upwardly to engage with an outer surface of an upper section of wall element, the generally vertical flange having a second generally vertical portion extending downwardly to engage with an outer surface of a lower section of wall element.

Ideally, the generally vertical flange is a tapered flange such that its end or ends distal the end extending from the generally horizontal projection is tapered.

Advantageously, the taper of the generally vertical flange allows for easier placement of fire suppression material therebehind.

In an alternative embodiment, preferably the first and/or second wall engagement portions comprise opposing retaining members.

Preferably, one of said opposing retaining members is an upper retaining member and the other of said opposing pair being a lower retaining member such that the upper and lower retaining members may engage and retain a section of wall element therebetween.

Ideally, one of said opposing retaining members being an upper retaining member locatable proximal the upper end of the spanning member and the other of said opposing pair being a lower retaining member being locatable proximal the bottom of said spanning member such that the upper and lower retaining members may engage and retain a section of wall element therebetween.

Preferably, the upper and lower retaining members each comprise a generally horizontal projection extending from the spanning member.

Ideally, the upper retaining member further comprises a downwardly depending generally vertical projection.

Preferably, the downwardly depending generally vertical projection extends from the end of the generally horizontal projection of the upper retaining member distal the end which is proximal the spanning member.

Preferably, the lower retaining member further comprises an upwardly depending generally vertical projection.

Ideally, the upwardly depending generally vertical projection extends from the end of the generally horizontal projection of the lower retaining member distal the end which is proximal the spanning member.

Optionally, the first wall engagement portion comprises the opposing retaining members.

Optionally, the second wall engagement portion comprises the opposing retaining members.

Alternatively, both the first and second wall engagement portions comprises the opposing retaining members.

Ideally, the fire suppression material is secured to the support via at least one mechanical fastener.

Preferably, the at least one mechanical fastener is at least one screw.

Ideally, the at least one screw is screwed through the fire suppression material and into the support.

Preferably, the at least one screw is provided with a washer.

Ideally, the washer is locatable in use on the non-support facing surface of the fire suppression material.

Preferably, the at least one screw is sized such that when screwed through the fire suppression material and into the support said screw extends into the concrete receiving cavity.

Advantageously, when the concrete is poured pumped, or otherwise placed into the concrete receiving cavity and thereafter sets, at least a portion of the at least one screw becomes encased in aid concrete which further acts to retain said screw and the fire suppression material associated therewith, in particular in the event of a fire.

Preferably, the fire suppression material is mineral wool.

According to a second aspect of the invention there is provided a fire suppression assembly comprising at least one portion of fire suppression material and at least one support, the at least one support comprising; a spanning member configured to span between first and second wall elements to define a concrete receiving cavity therebetween; wherein the support comprises at least one retaining member associated with the spanning member, the at least one retaining member being configured to retain a portion of the fire suppression material relative to the spanning member such that said portion of fire suppression material may form at least a portion of at least one of said first and second wall elements.

Preferably, at least a portion of the first and second wall elements are formed from wall forming panels such as Expanded Polystyrene (EPS) panels attachable to the support.

According to a third aspect of the invention there is provided a method of forming a wall or portion thereof comprising a fire suppression assembly, the method comprising the steps of: providing a plurality of supports each comprising a spanning member configured to span between first and second wall elements to define a concrete receiving cavity therebetween; wherein the supports comprise at least one retaining member associated with the spanning member, the at least one retaining member being configured to retain a portion of the fire suppression material relative to the spanning member such that said portion of fire suppression material may form at least a portion of at least one of said first and second wall elements, retaining at least one portion of fire suppression material via the at least one retaining member; and filling the concrete receiving cavity to form a wall or portion thereof having the at least one portion of fire suppression material.

Preferably, the method further comprising the step of forming at least a portion of the first and second wall elements from wall forming panels such as Expanded Polystyrene (EPS) panels which are attachable to the support.

### BRIEF DESCRIPTION OF THE DRAWINGS

An embodiment of the invention is now described by way of example and with reference to the accompanying drawings in which:

FIG. 1 is an isometric view of a first embodiment of a support for a fire suppression assembly of a building wall comprising one retaining member for retaining fire suppression material;

FIG. 2 is a front view of the support of FIG. 1;

FIG. 3 is a plan view of the support of FIG. 1;

FIG. 4 is a left side view of the support of FIG. 1;

FIG. 5 is an isometric view of a second embodiment of a support for a fire suppression assembly of a building wall comprising two retaining members for retaining fire suppression material, one retaining member being locatable on each side of the support;

FIG. 6 is a front view of the support of FIG. 5;

FIG. 7 is a plan view of the support of FIG. 5;

FIG. 8 is a left side view of the support of FIG. 5;

FIG. 9 is an isometric view of a third embodiment of a support for a fire suppression assembly of a building wall comprising three retaining members for retaining fire suppression material;

FIG. 10 is a front view of the support of FIG. 9;

FIG. 11 is a plan view of the support of FIG. 9;

FIG. 12 is a left side view of the support of FIG. 9;

FIG. 13 is an isometric view of a fourth embodiment of a support for a fire suppression assembly of a building wall comprising two retaining members for retaining fire suppression material, the two retaining members being locatable on the same side of the support;

FIG. 14 is a front view of the support of FIG. 13;

FIG. 15 is a plan view of the support of FIG. 13;

FIG. 16 is a left side view of the support of FIG. 13;

FIG. 17 is an isometric view of a fifth embodiment of a support for a fire suppression assembly of a building wall comprising four retaining members for retaining fire suppression material, two retaining members being locatable on each side of the support;

FIG. 18 is a front view of the support of FIG. 17;

FIG. 19 is a plan view of the support of FIG. 17;

FIG. 20 is a left side view of the support of FIG. 17;

FIG. 21 is an isometric view of a section of a wall forming assembly wherein the wall elements are all formed from Expanded Polystyrene (EPS) panels;

FIG. 22 is an isometric view of the wall forming assembly of FIG. 21 having a portion of EPS cut away;

FIG. 23 is an isometric view of a wall forming assembly employing the support of FIGS. 1 to 4 showing a portion of fire suppression material prior to its engagement with a retaining member;

FIG. 24 is an isometric view of a the wall forming assembly of FIG. 23 showing the portion of fire suppression material in position wherein it is retained by the retaining member;

FIG. 25 is an isometric view of a wall forming assembly employing the support of FIGS. 5 to 8;

FIG. 26 is an isometric view of a the wall forming assembly of FIG. 23 showing portions of fire suppression material in position wherein they are retained by the retaining members;

FIG. 27 is an isometric view of a wall forming assembly employing the support of FIGS. 17 to 20 showing portions of fire suppression material in position wherein they are retained by the retaining members;

FIG. 28 is an isometric view of a wall forming assembly employing the support of FIGS. 13 to 15 showing portions of fire suppression material in position wherein they are retained by the retaining members;

FIG. 29 is an isometric view of a wall forming assembly employing the support of FIGS. 9 to 12 showing portions of fire suppression material in position wherein they are retained by the retaining member;

FIG. 30 is an isometric view of a sixth embodiment of a support for a fire suppression assembly of a building wall comprising to opposing retaining members for retaining fire suppression material on each side of the support;

FIG. 31 is a front view of the support of FIG. 30;

FIG. 32 is a left side view of FIG. 30;

FIG. 33 is an isometric view of a wall forming assembly employing the support of FIGS. 30 to 32 showing portions of fire suppression material in position wherein they are retained by the retaining members;

FIG. 34 is an isometric view of a wall forming assembly employing a support comprising opposing retaining members on one side only thereof and showing a portion of fire suppression material in position wherein it is retained by the retaining members;

FIG. 35 is an isometric view of a wall forming assembly employing a support comprising opposing retaining members on one upper quadrant only thereof and showing a portion of fire suppression material in position wherein it is retained by the retaining members; and

FIG. 36 is an isometric view of a wall forming assembly employing a support comprising opposing retaining members on both upper quadrants only thereof and showing portions of fire suppression material in position wherein they are retained by the retaining members.

### DETAILED DESCRIPTION OF THE DRAWINGS

The present teaching will now be described with reference to an exemplary support for a fire suppression assembly and assembly comprising the same. It will be understood that the exemplary support, assembly, and associated method is provided to assist in an understanding of the present teaching and are not to be construed as limiting in any fashion. Furthermore, elements or components that are described with reference to any one Figure may be interchanged with those of other Figures or other equivalent elements without departing from the spirit of the present teaching.

Referring now to the Figures there is illustrated a support 10 for a fire suppression assembly 100 of a building wall. The support 10 has a spanning member 11 which is sized to span between first and second wall elements 12, 13 to define a concrete receiving cavity 14 therebetween. The support 10 has at least one retaining member 15 associated with the spanning member 11, the at least one retaining member 15 being sized and dimensioned to retain a portion of fire suppression material 16 relative to the support 10 such that said portion of fire suppression material 16 may form at least a portion of at least one of said first and second wall elements 12, 13. Advantageously, at least one portion of fire suppression material 16 may be retained relative to the support 10 and form part of the resulting wall structure once the concrete receiving cavity 14 is filled with concrete, thus providing at least a section of wall across which fire is supressed from spreading. This can, for example, be seen in FIG. 28, which shows retaining members 15 retaining fire suppression material such that it forms the second wall element, the first wall element being formed from an Expanded Polystyrene (EPS) panel 19 or the like. As such, where the second wall of the assembly of FIG. 28 spans across, for example, a floor structure which divides two floors within a building, should a fire start below said floor structure it is supressed from travelling through the second wall element to the space above the floor structure. This can therefore prevent fires from spreading through a building by travelling through wall sections, as can be the case where wall sections comprise uninterrupted sections of EPS or other such material.

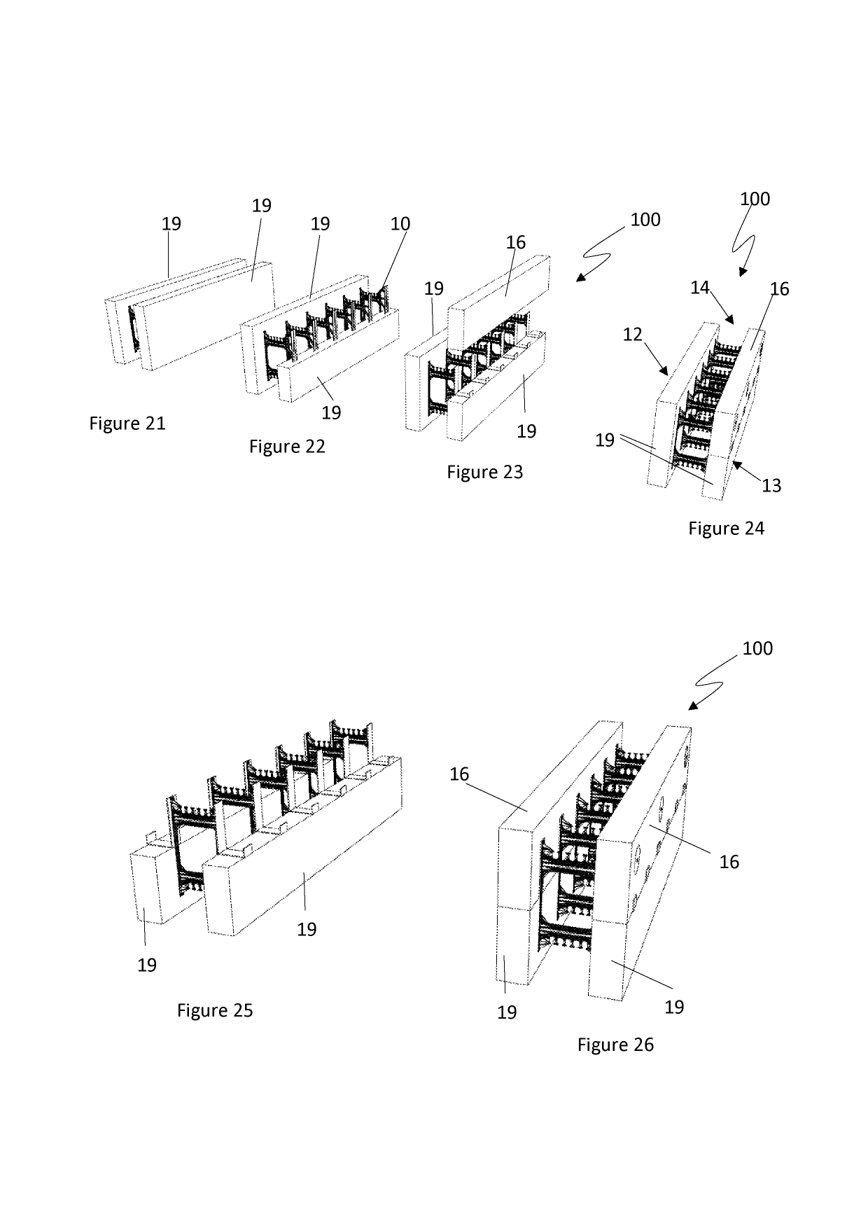

The wall elements 12, 13 are wall forming portions 12, 13 which act to define the concrete forming cavity 14 therebetween to retain concrete once pumped, poured or otherwise placed thereinto, and provide insulative and/or fire suppression properties on the external surfaces of the concrete once set. In known such concrete form arrangements, all of the wall portions are formed from EPS or other such insulative panel members (as is shown in FIG. 21) and any fire suppression is achieved by application of metal strips or flashing after wall construction to inhibit spreading of fire. Therefore, the present invention permits portions of fire suppression material to be integrated into the formed wall such that no or limited application of such fire suppression elements is required after forming of the wall.

The support 10 has first and second wall element engagement portions 17, 18 for engaging with respective first and second wall elements 12, 13. The first and second wall engagement portions 17, 18 may each comprise an upper wall element engagement portion for engaging with upper sections of the first and second wall elements and a lower wall element engagement portion for engaging with upper sections of the first and second wall elements. Broadly, the wall engagement portions may be formed by the lateral sides 17, 18 of the support 10 which are proximal the wall elements when in use.

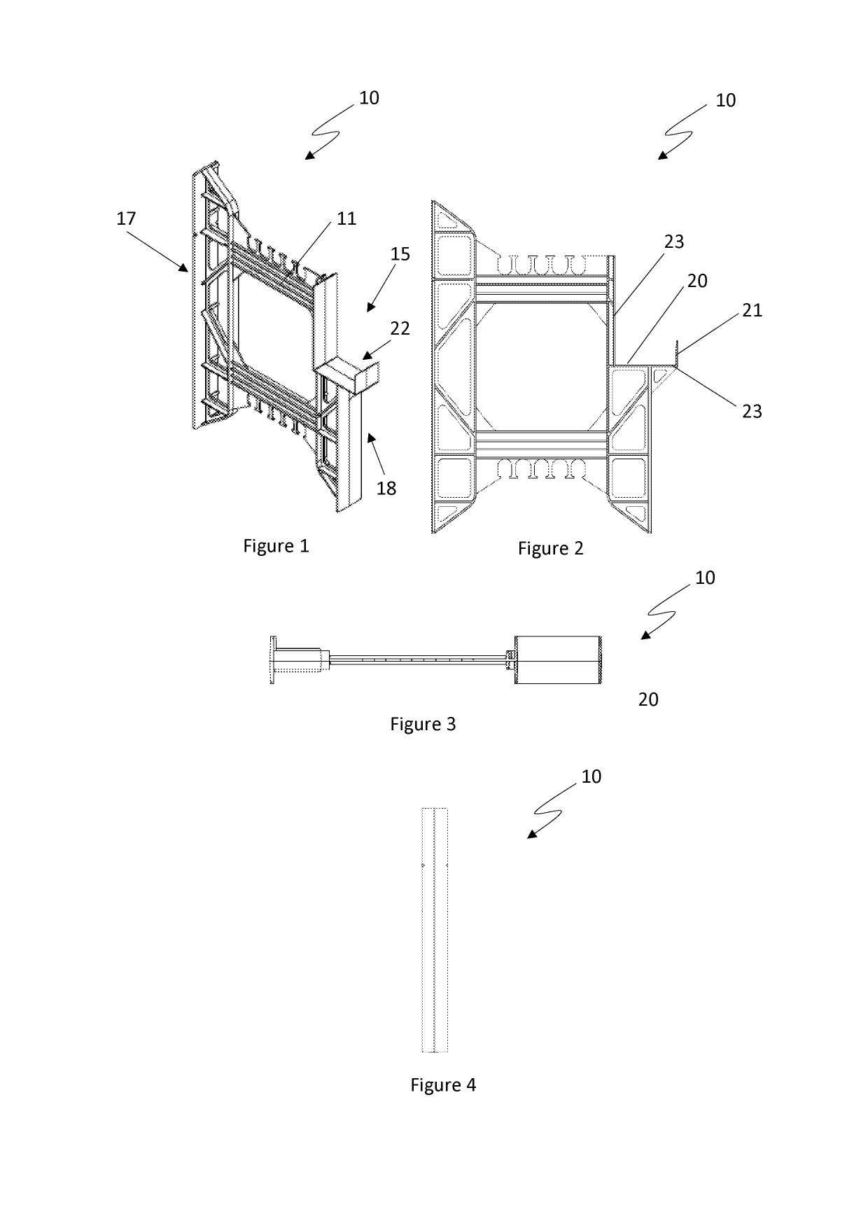

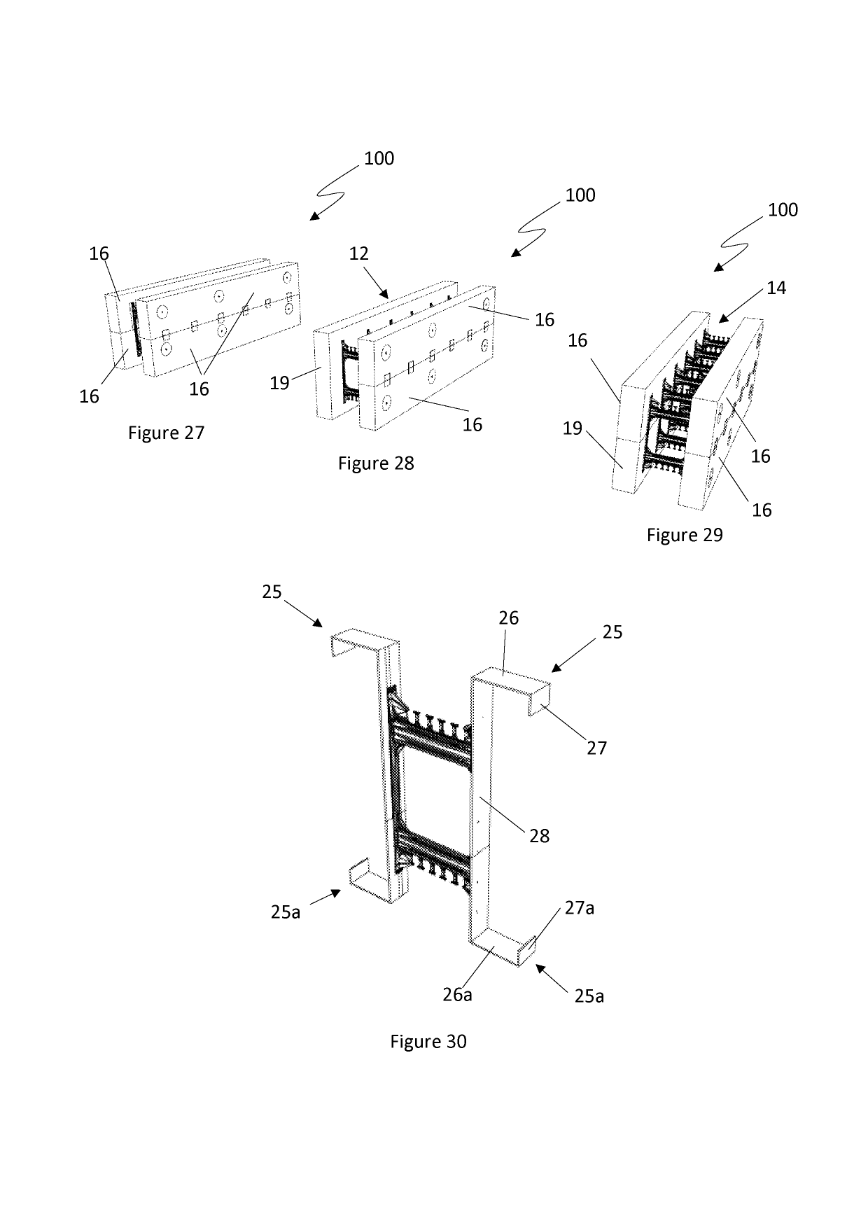

In a first set of embodiments as is shown in FIGS. 1 to 29, the wall engagement portions 17, 18 can broadly be considered as being located in four quadrants of the support and positioned to engage with a respective four areas or sections of the wall elements 12, 13. However, it should be understood that, whilst an embodiment as is shown in FIG. 27 is envisaged wherein each of the upper and lower wall element engagement portions engage with separate sections of wall element, the upper and lower wall engagement portions of either wall engagement portion 17, 18 may simply engage with the upper and lower section of a unitary section of wall element, such as is shown in FIG. 28 in relation to the first (left hand) wall element 12 thereof. In such a situation, the upper and lower wall engagement portion of a given wall engagement portion 17, 18 is simply a single wall engagement portion extending vertically to engage with an upper and lower portion of a section of wall element, such a wall engagement portion can be seen in the first wall engagement portion 17 of FIG. 1.

The retaining members 15 may form any number of the wall element engagement portions 17, 18 or their upper and/or lower portions. By this, it is meant that, retaining members 15 can be employed to retain fire suppression material 16 along one wall element 12, 13, along both wall elements 12, 13, or along an upper and/or lower portion of either or both wall element 12, 13. In this manner, considering the wall elements 12, 13 as engaging with quadrants of the support 10, any one of the quadrants, all of the quadrants, or any combination of quadrants therebetween can comprise fire suppression material 16 as its wall element. Any wall engagement portions 17, 18, or upper or lower portions thereof, not formed by retaining members 15 are configured to engage with wall forming panels such as Expanded Polystyrene (EPS) panels 19 or the like. The wall engagement portions, or parts thereof, which engage with EPS panels generally comprise a webbed extrusion which may be embedded or attached to the EPS by any suitable means. Advantageously, a portion of wall may be created which comprises fire suppression material 16 forming all sections of its wall elements 12, 13, or may have a mixture of wall elements, at least one comprising fire suppression material 16 and the remainder comprising Expanded Polystyrene (EPS) panels 19 or the like. It should also be understood that the skilled person would know of and/or could devise a multitude of ways in which to attach the supports and EPS panels and all such ways would therefore fall within the scope of the present invention. The fire suppression material 16 in a preferred embodiment is mineral wool, however it should be understood that any suitable material with properties which supress or inhibit the spread of fire therethrough may be utilised.

The retaining members 15 comprise at least one retaining flange or bracket 15, the mineral wool 16 being retained by said flange or bracket 15. The flange or bracket 15 comprises at least one generally horizontal projection 20, and at least one generally vertical projection 21 extending from the horizontal projection 20. The generally horizontal projection 20 inhibits or prevents mineral wool 16 from moving vertically and the generally vertical projection 21 inhibits or prevents the fire mineral wool 16 from moving horizontally. As can be seen for example in FIG. 1, the generally horizontal and vertical projections 20, 21 form a channel 22 in combination with a vertical section 23 of the spanning member 11 and the mineral wool 16 may be received and retained in said channel 22. It should be understood that the vertical section of the spanning member 23 may actually form part of the retaining member 15.

The first and/or second wall engagement portions 17, 18 comprise at least one retaining member 15, the at least one retaining member 15 comprising the generally horizontal projection 20 extending from the spanning member 11. The generally horizontal projection 20 is located generally centrally in the vertical dimension of the spanning member 11. However, it should be understood that placement of the generally horizontal projection 20 and resulting retaining member 15 need not necessarily be central and could be lower or higher than the central position of FIG. 1 such that portions of mineral wool 16 could form all or any portion of the vertical extent of a wall element depending on placement of said retaining member 15. Where up, down, upwards, downwards, upwardly, downwardly, vertical, or horizontal are referred to herein it should be understood that these terms take their generally understood meaning and are relative to the support as in use in an assembly to form a wall, as can for example be seen in FIG. 25.

The generally horizontal and generally vertical projections 20, 21 are flange like projections 20, 21 and as such may be referred to herein as the horizontal flange and vertical flange. However, it should be understood that these elements need not extend strictly horizontally and vertically in order to achieve the intended function. The horizontal flange 20 comprises an upwardly depending vertical flange 21 extending from its end 23 distal the end which is proximal the spanning member 11 to form a single retaining member 15 with the horizontal flange 20, this arrangement can for example be seen in FIG. 1. Advantageously, such a single retaining member arrangement 20, 21 may retain mineral wool 16 to form the upper section of either wall element 12, 13. A downwardly depending vertical flange 21a may also extend from the end 23 of the horizontal flange 20 distal the end of which is proximal the spanning member 11 to form a second retaining member 15a with the horizontal flange 20. Thus the horizontal flange 20 may form part of a single retaining member 15 or may act as a common horizontal flange 20 to form duel retaining members 15, 15a with respective upward and downwardly depending vertical flanges 21, 21a, such an arrangement being visible in FIG. 10 for example. Advantageously, such a duel retaining member arrangement 20, 21, 21a may retain mineral wool 16 to form both the upper and lower sections of either wall element 12, 13. It should also be appreciated that single retaining members 15 may be formed by a horizontal flange 20 and a downwardly depending vertical flange 21a. It should further be understood that in stating that the vertical flanges 21, 21a extend from the end 23 of the horizontal flange 20, this is not intended to be limiting and the vertical flanges may extend from any portion of the horizontal flange which matches the thickness of mineral wool to be retained thereby. The horizontal flange 20 is sized and vertical flange or flanges 21, 21a placed such that a desired thickness of mineral wool 16 spans the horizontal flange 20 and is retained horizontally by the vertical flange or flanges 21, 21a.

In some embodiments, only one of the wall engagement portions 17, 18 of the support 10 comprise a single or dual retaining member 15, 15a. In some embodiments, both wall engagement portions 17, 18 comprise a single or dual retaining member 15, 15a. Therefore, different supports 10 may be formed which may retain mineral wool 16 on an upper portion of one or both wall engagement portions 17, 18, on a lower portion of one or both engagement portions 17, 18, on the upper portion of either wall engagement portion 17, 18 and lower portion of the other respective wall engagement portion 17, 18, or on both the upper and lower portions of one or both wall engagement portions 17, 18. Therefore, an assembly for forming a wall utilising said supports 10 is flexible and may be adapted to form a wall having mineral wool or other such fire suppression material 16 at any position required by selecting the appropriate support 10.

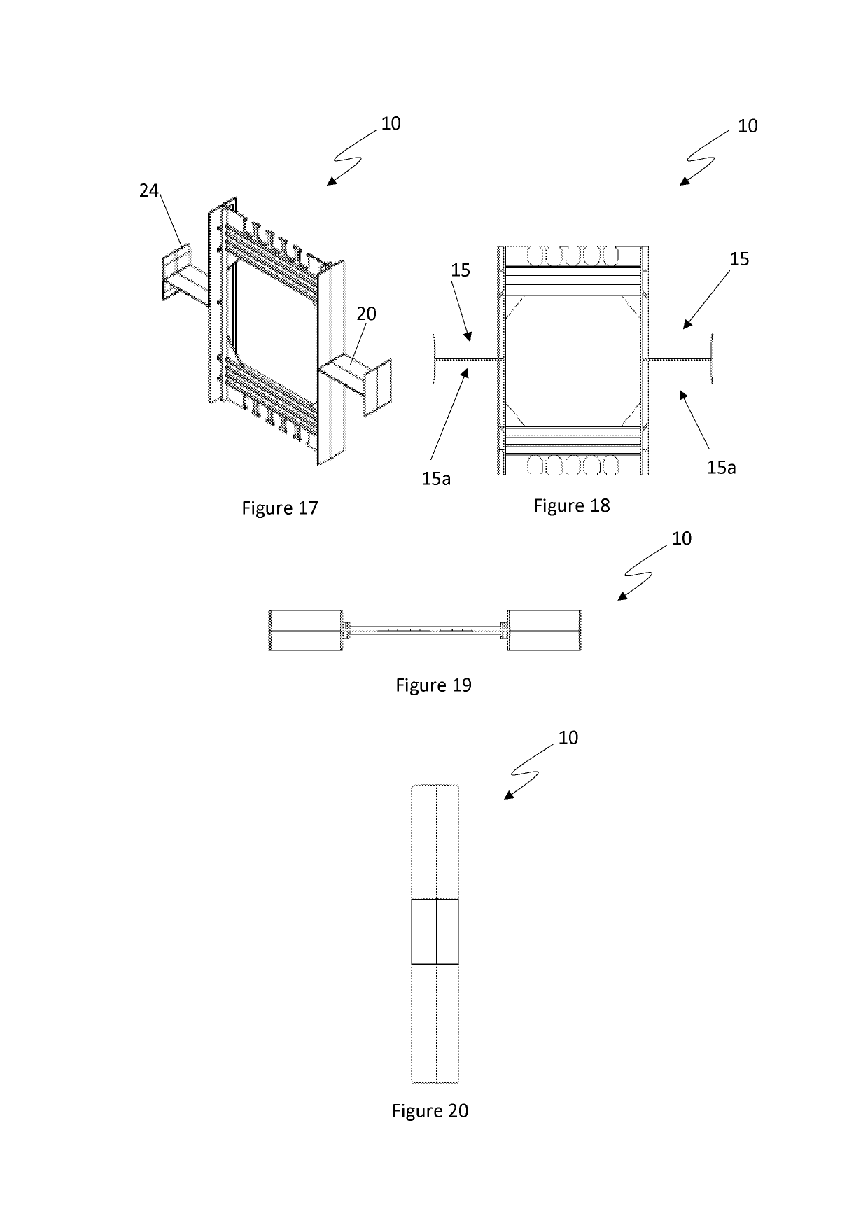

The vertical flanges 21, 21a may be tapered flanges 21, 21a such that their end or ends 24, 24a distal the end extending from the horizontal flange 20 is tapered. Advantageously, the taper of the vertical flanges 21, 21a allows for easier placement of fire suppression material therebehind. The vertical flanges 21, 21a may also be formed as one integral flange that extends across the end 23 of the horizontal flange 20, as can be seen for example in FIG. 17.

FIGS. 1 to 20 show five different embodiments of the invention which in general disclose supports 10 capable of retaining mineral wool 16 in various positions relative thereto. FIGS. 1 to 4 disclose a first embodiment wherein a single retaining member 15 is located centrally on one side of the support 10 and comprises a horizontal flange 20 extending from said generally central position and a vertical flange 21 extending upwardly from the end of the horizontal flange 20. This embodiment is designed to retain mineral wool 16 to form the upper section of one wall element 13 as is shown in FIGS. 23 and 24. The first embodiment may, for example, be utilised where a floor structure meets the wall to be formed by the present invention at an upper section of one of the wall elements 12, 13, the mineral wool 16 acting to supress propagation of any fire from below said floor structure to above thereof, or from above said floor structure to below, at the edge of the floor structure where it meets the portion of wall element 12, 13 formed by the mineral wool 16.

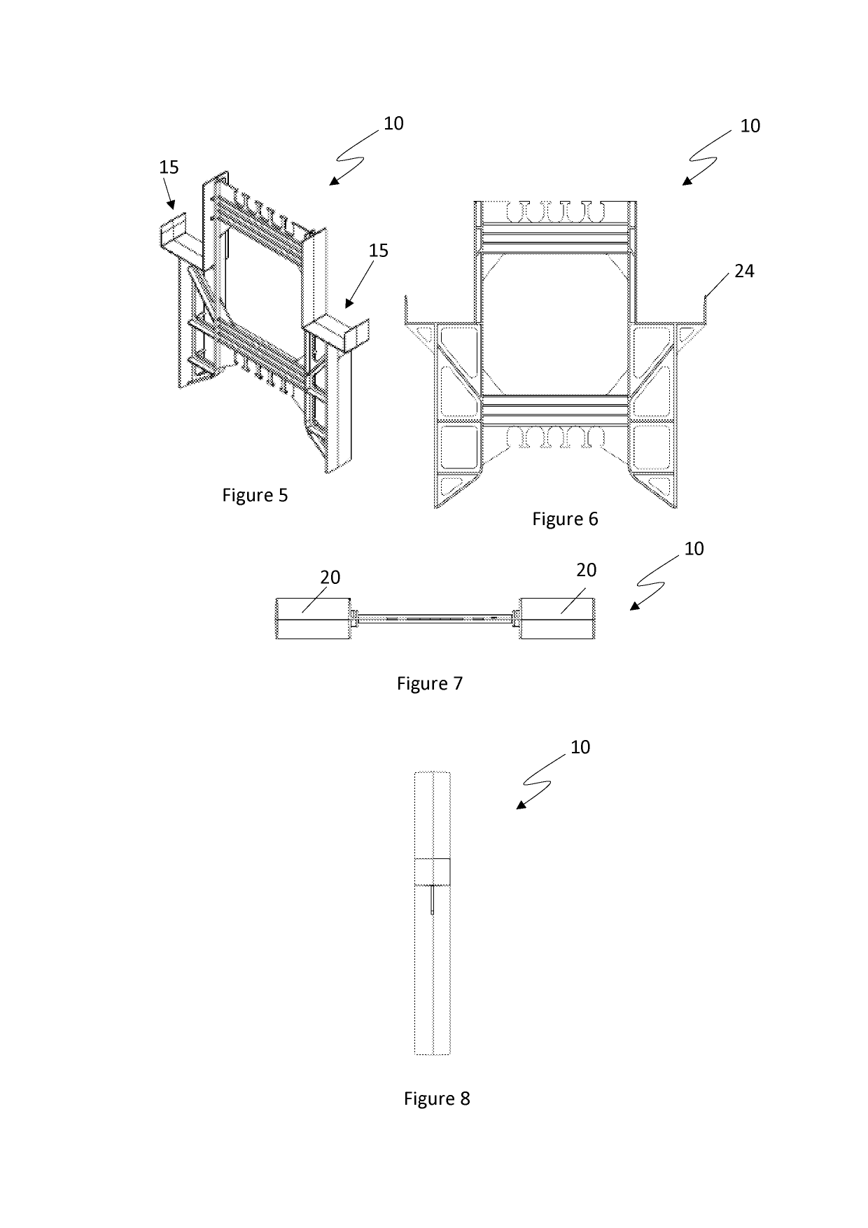

FIGS. 5 to 8 disclose a second embodiment wherein a single retaining member 15 is located centrally on each side of the support 10 and each retaining member comprises a horizontal flange 20 extending from said generally central position and a vertical flange 21 extending upwardly from the end of the horizontal flange 20. This embodiment is designed to retain mineral wool 16 to form the upper section of both wall elements 12, 13 as is shown in FIGS. 25 and 26. The second embodiment may, for example, be utilised where a floor structure meets the wall to be formed by the present invention at an upper section of both of the wall elements 12, 13, such as in a party wall between two semi-detached properties. The mineral wool 16 acts to supress propagation of any fire from below said floor structures to above thereof, or from above said floor structures to below at the edge of the floor structures where they meets the portion of wall element 12, 13 formed by the mineral wool 16.

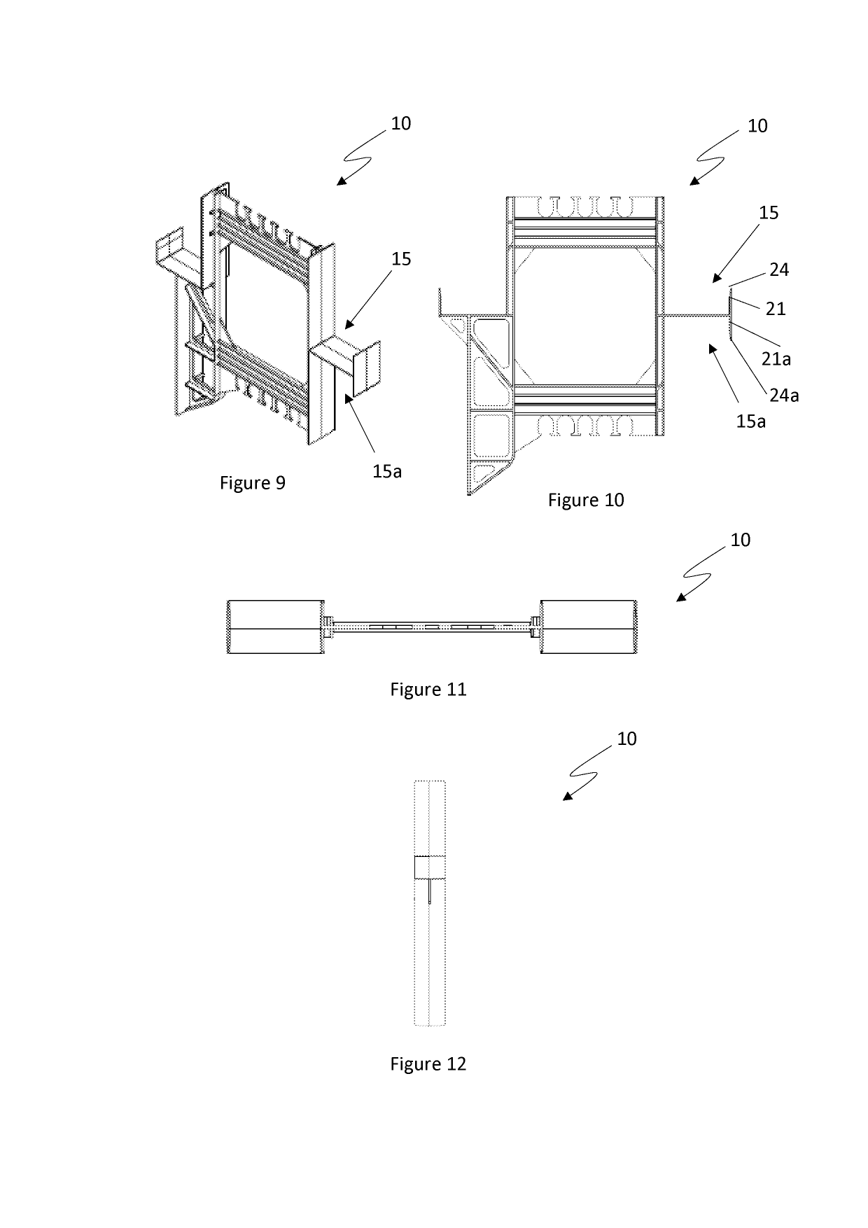

FIGS. 9 to 12 disclose a third embodiment wherein a single retaining member 15 is located centrally on a first side of the support 10 and comprises a horizontal flange 20 extending from said generally central position and a vertical flange 21 extending upwardly from the end of the horizontal flange 20. A dual retaining means 15, 15a is located centrally on a second side of the support 10 and comprises a common horizontal flange 20 extending from said generally central position and having both upwardly and downwardly depending vertical flanges 21, 21a extending from the common horizontal flange 20. This embodiment is designed to retain mineral wool 16 to form the upper section of one wall element 12 and the upper and lower sections of the other respective wall element 13, as can be best seen in FIG. 29. The third embodiment may, for example, be utilised where a staircase structure meets the wall to be formed by the present invention on one side and a floor structure meets the wall to be formed on the other side. In the case of a staircase a firestop must be created which runs generally in line with the tread of the stairs.

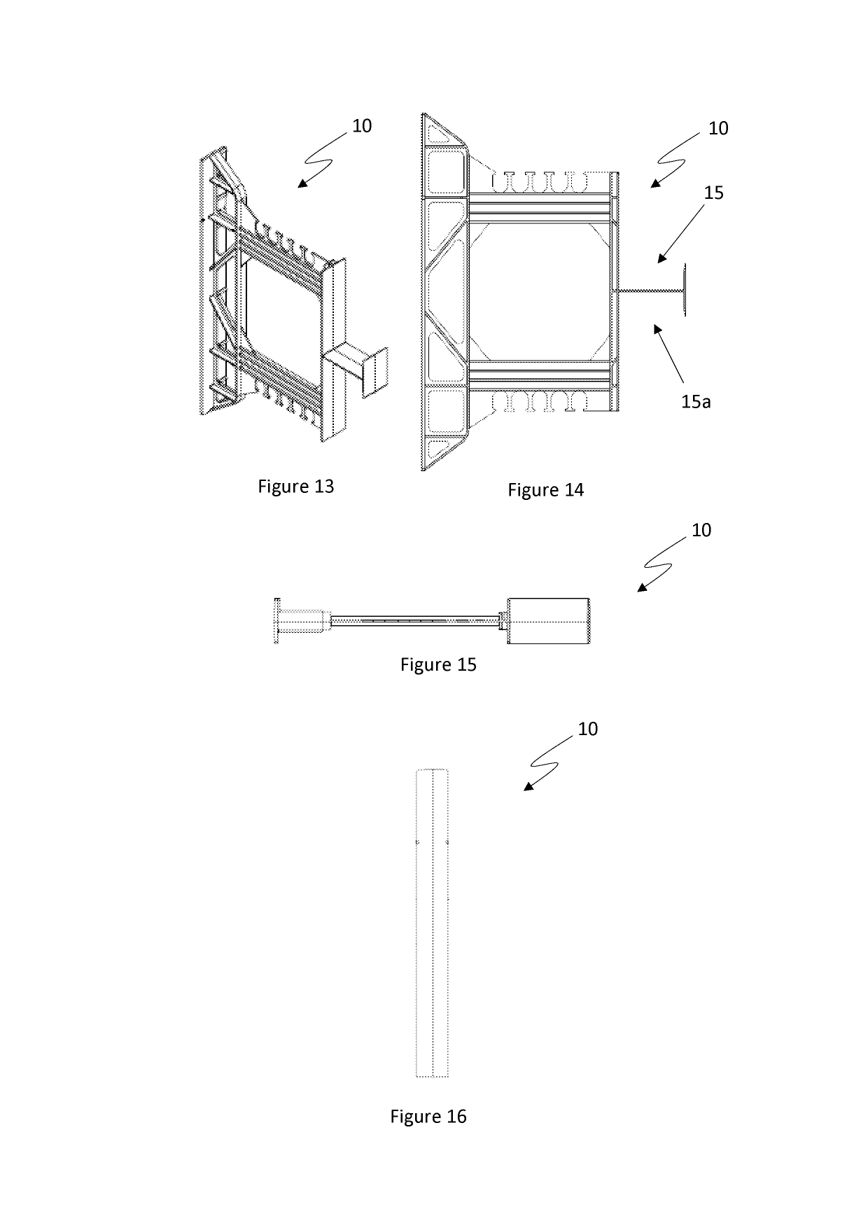

FIGS. 13 to 16 disclose a fourth embodiment wherein a dual retaining means 15, 15a is located centrally on one side of the support 10 and comprises a common horizontal flange 20 extending from said generally central position and having both upwardly and downwardly depending vertical flanges 21, 21a extending from the common horizontal flange 20. This embodiment is designed to retain mineral wool 16 to form the upper and lower sections of one wall element 12, 13, as can best be seen in FIG. 28. The fourth embodiment may, for example, be utilised where a staircase structure meets the wall to be formed by the present invention on one side as a firestop must be created which runs generally in line with the tread of the stairs.

FIGS. 17 to 20 disclose a fifth embodiment wherein a dual retaining means 15, 15a is located centrally on each side of the support 10 and each dual retaining member 10 comprises a common horizontal flange 20 extending from said generally central position and having both upwardly and downwardly depending vertical flanges 21, 21a extending from the common horizontal flange 20. This embodiment is designed to retain mineral wool 16 to form the upper and lower sections of both wall elements 12, 13, as can best be seen in FIG. 27. The fifth embodiment may, for example, be utilised where a staircase structure meets the wall to be formed by the present invention on both sides or where two flights of a staircase are separated by the wall to be formed, as a firestop must be created which runs generally in line with the tread of the stairs.

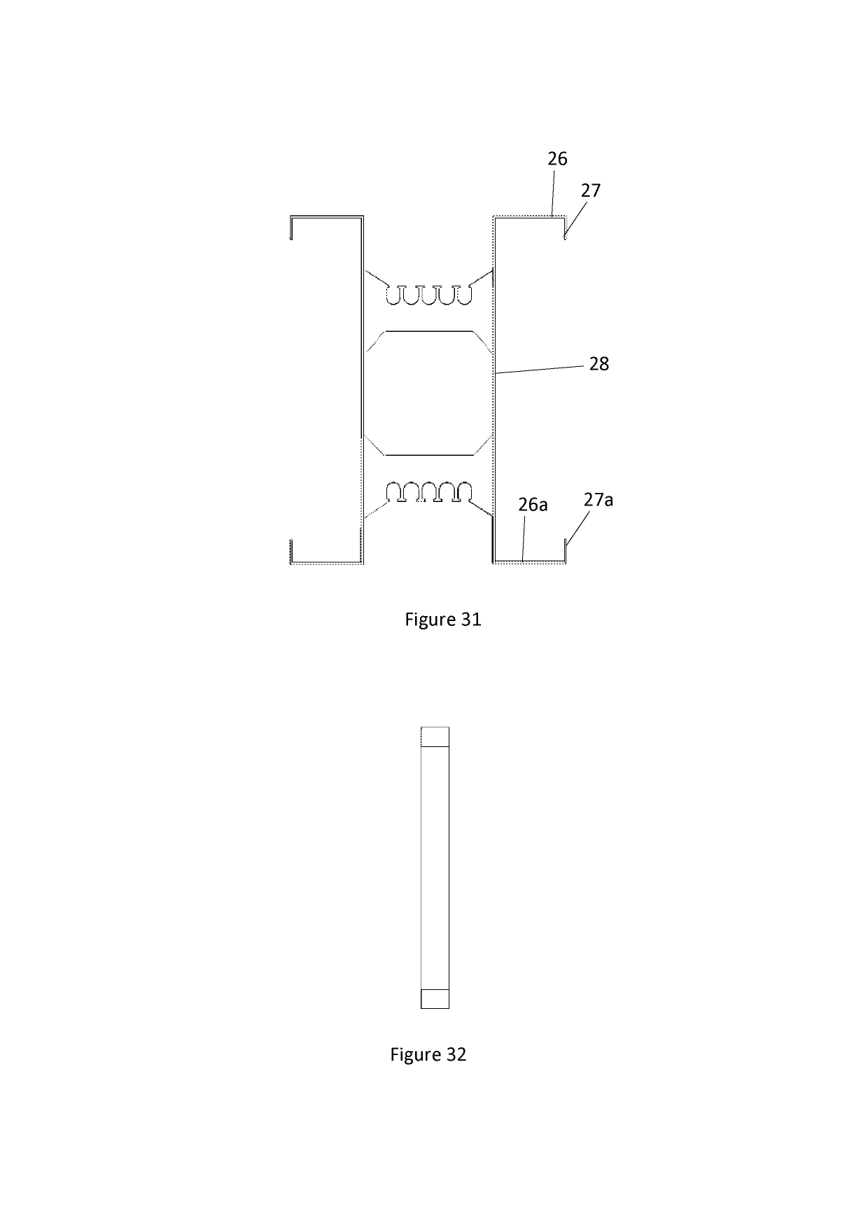

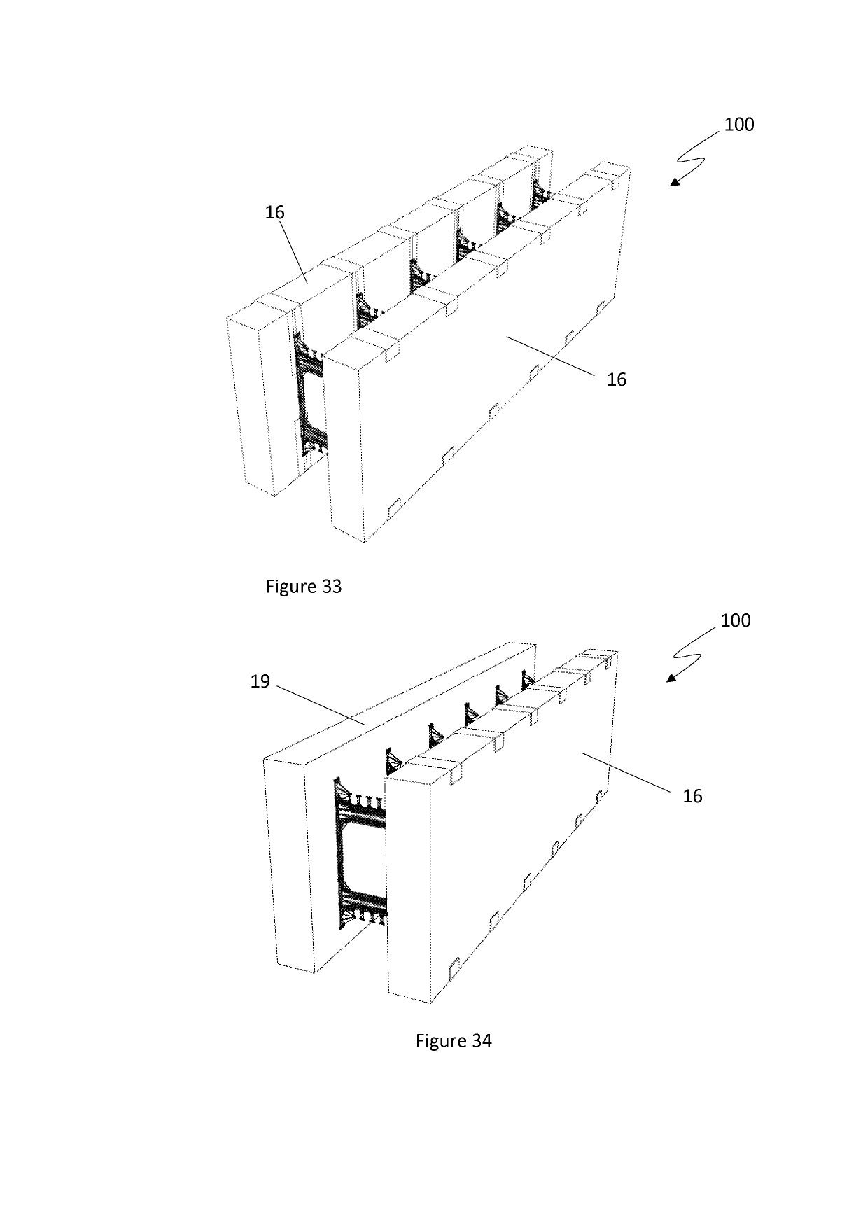

An sixth alternative embodiment is shown in FIGS. 30 to 36 in which the first and/or second wall engagement portions 17, 18 comprise opposing retaining members 25, 25a, one of said opposing retaining members 25, 25a being an upper retaining member 25 locatable proximal the upper end of the spanning member 11 and the other of said opposing pair being a lower retaining member 25a being locatable proximal the bottom of said spanning member 11 such that the upper and lower retaining members 25, 25a may engage and retain a section of wall element therebetween, as is for example shown in FIG. 33. The upper retaining member 25 may be located above the upper end of the spanning member 11 and the lower retaining member 25a may be located below the bottom of the spanning member 11. The opposing retaining members 25, 25a take a similar form to those described in relation to embodiments 1 to 5 in that they comprise horizontal flanges 26, 26a, with the upper retaining member 25 having a downwardly depending vertical flange 27 and the lower retaining member 25a having an upwardly depending vertical flange 27a forming opposing brackets 25, 25a between which mineral wool 16 may be retained. The horizontal flanges 26, 26a extend from a generally vertical connecting element 28 which extends vertically along the wall element facing side of the spanning member 11. Whilst the embodiment of the support shown in FIGS. 30 to 33 discloses each side of the support 10 comprising a pair of opposing retaining members 25, 25a, it should be understood that only one side of the support may comprise the opposing retaining members 25, 25a as is shown in FIG. 34.

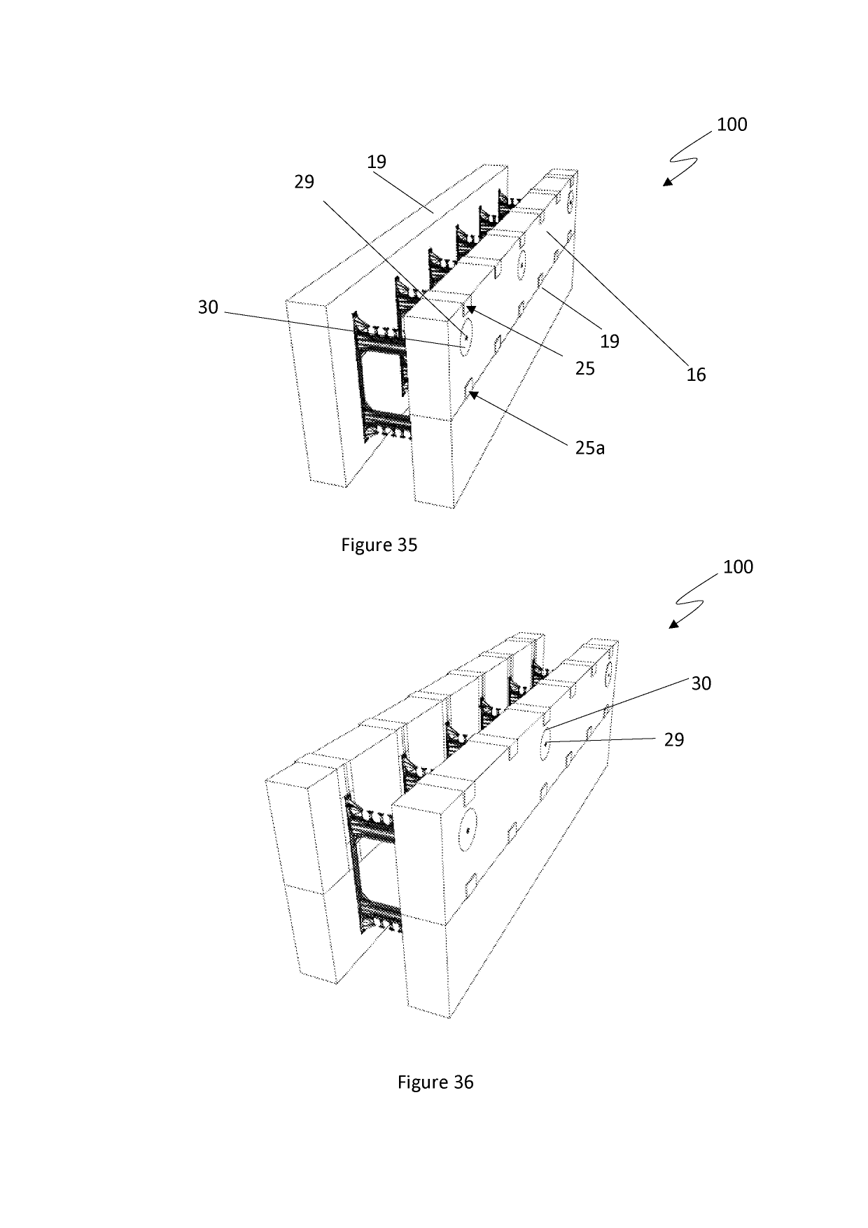

A further embodiment is shown in FIGS. 35 and 36. In this embodiment the opposing retaining members 25, 25a are disposed such that the lower retaining member 25a is located generally centrally on the support 10. This permits embodiments having the opposing retaining members to be employed to selectively retain mineral wool 16 to form upper sections of the wall elements 12, 13 only. It should be appreciated that the opposing retaining member arrangement of FIG. 35 may also be adapted such that it is the upper retaining member 25 that is located generally centrally and the opposing retaining element 25 may then retain mineral wool 16 to form a lower section of a wall element 12, 13. Therefore, embodiments employing opposing retaining members 25, 25a may be equally as flexible in relation to use case as embodiments 1 to 5 in that they may be used to retain mineral wool 16 such that the resulting first and second wall elements 12, 13 may be entirely comprised of mineral wool, or have mineral wool on their upper or lower sections.

In all embodiments described herein, the mineral wool 16 may be secured to the support 10 via mechanical fasteners 29 which in a preferred case are screws 29. The screws 29 are screwed through the mineral wool 16 and into the support 10. The screws are provided with washers 30 locatable in use on the non-support facing surface of the mineral wool 16 and which permit the screws to apply a force to a greater surface area of the mineral wool 16 and thus better retain the mineral wool 16 in place. The screws 29 are sized such that when screwed through the fire mineral wool 16 and into the support 10 said screw extends into the concrete receiving cavity 14. Advantageously, when the concrete is poured pumped, or otherwise placed into the concrete receiving cavity 14 and thereafter sets, at least a portion of the screws 29 becomes encased in said concrete, which further acts to retain said screws 29 and the mineral wool 16 associated therewith, in particular in the event of a fire. It should also be understood that, where the screws or mechanical fixings are present embodiments are envisaged where said screws or mechanical fixings may replace all or some of the retaining members and as such these embodiments fall within the scope of the presently claimed invention. In a preferred case, the supports 10 of all herein described embodiments are manufactured from a suitable plastic material such as polypropylene.

A fire suppression assembly 100 may be formed as is shown in FIGS. 21 to 29 and 33 to 36 comprising at least one portion of mineral wool 16 material and a plurality of the herein described supports. The supports are used in a spaced apart arrangement between two wall elements 12, 13 to define a concrete receiving cavity 14. The composition of the wall elements is determined based upon any fire suppression requirements and the supports 10 having appropriately placed retaining members 15, 15a, 25, 25a are chosen such that mineral wool 16 may be retained in a suitable position such that it may form sections of the wall elements 12, 13 which correspond to the sections requiring fire suppression. Any remaining sections of the wall elements 12, 13 not requiring fire suppression are comprised of EPS panel material. The mineral wood is secured using screws 29 which extend through the supports 10 and into the concrete receiving cavity 14. A wall having selectively placed mineral wool 16 may then be formed using the resulting assembly 100 by filling the concrete receiving cavity 14 with concrete and allowing the same to set.

The invention is not limited to the embodiment(s) described herein but can be amended or modified without departing from the scope of the present invention.

1. A support for a fire suppression assembly of a building wall, the support comprising:
a spanning member configured to span between first and second wall elements to define a concrete receiving cavity therebetween;
wherein the support comprises at least one retaining member associated with the spanning member, the at least one retaining member being configured to retain a portion of fire suppression material relative to the support such that said portion of fire suppression material may form at least a portion of at least one of said first and second wall elements.

2. The support of claim 1, further comprising first and second wall element engagement portions for engaging with respective first and second wall elements.

3. The support of claim 2, wherein the first and second wall engagement portions each comprise an upper wall element engagement portion and a lower wall element engagement portion for engaging with respective upper and lower sections of the first and second wall elements.

4. The support of claim 2, wherein retaining members form any number of the wall element engagement portions, and any wall engagement portions not formed by retaining members are configured to engage with wall forming panels such as Expanded Polystyrene (EPS) panels.

5. The support of any of claim 1, wherein the at least one retaining member comprises at least one retaining flange or bracket, the fire suppression material being retained by said flange or bracket.

6. The support of claim 5, wherein the flange or bracket comprises at least one generally horizontal projection.

7. The support of claim 6, wherein the at least one generally horizontal projection comprises at least one generally vertical projection extending therefrom such that the generally horizontal projection inhibits or prevents fire suppression material from moving vertically and the generally vertical projection inhibits or prevents the fire suppression material from moving horizontally.

8. The support of claim 6, wherein at least the first and/or second wall engagement portion comprises at least one retaining member, the at least one retaining member comprising a generally horizontal projection extending from the spanning member, said generally horizontal projection being located generally centrally in the vertical dimension of the spanning member.

9. The support of claim 8, wherein the generally horizontal projection comprises an upwardly depending vertical projection extending from its end distal the end which is proximal the spanning member to form a first retaining member with the generally horizontal projection and/or a downwardly depending vertical projection extending from its end distal the end which is proximal the spanning member to form a second retaining member with the generally horizontal projection such that the at least one retaining member may retain fire suppression material to form the upper and/or lower sections of the first wall element.

10. The support of claim 8, wherein the first wall engagement portion or the second wall engagement portion comprises the at least one retaining member.

11. The support of claim 8, wherein both the first and second wall engagement portions comprise the at least one retaining member.

12. The support of claim 6, wherein the first and/or second wall engagement portions comprise opposing retaining members, one of said opposing retaining members being an upper retaining member and the other of said opposing pair being a lower retaining member such that the upper and lower retaining members may engage and retain a section of wall element therebetween.

13. The support of claim 12, wherein upper and lower retaining members each comprise a generally horizontal projection extending from the spanning member, and/or wherein the first wall engagement portion or the second wall engagement portion comprises the opposing retaining members, and/or wherein both the first and second wall engagement portions comprises the opposing retaining members.

14. The support of claim 13, wherein the upper retaining member further comprises a downwardly depending generally vertical projection extending from the end of its generally horizontal projection distal the end which is proximal the spanning member, and/or wherein the lower retaining member further comprises an upwardly depending generally vertical projection extending from the end of its generally horizontal projection distal the end which is proximal the spanning member.

15. The support of claim 1, wherein the fire suppression material may be secured to the support via at least one mechanical fastener, and/or wherein the fire suppression material is mineral wool.

16. The support of claim 15, wherein the at least one mechanical fastener is at least one screw which is screwed through the fire suppression material and into the support, said screw being optionally provided with a washer locatable in use on the non-support facing surface of the fire suppression material.

17. The support of claim 16, wherein the at least one screw is sized such that when screwed through the fire suppression material and into the support said screw extends into the concrete receiving cavity.

18. A fire suppression assembly comprising at least one portion of fire suppression material and at least one support, the at least one support comprising;
a spanning member configured to span between first and second wall elements to define a concrete receiving cavity therebetween;
wherein the support comprises at least one retaining member associated with the spanning member, the at least one retaining member being configured to retain a portion of the fire suppression material relative to the support such that said portion of fire suppression material may form at least a portion of at least one of said first and second wall elements.

19. The system of claim 18, wherein at least a portion of the first and second wall elements are formed from wall forming panels such as Expanded Polystyrene (EPS) panels attachable to the support.

20. A method of forming a wall or portion thereof comprising a fire suppression assembly, the method comprising the steps of:
providing a plurality of supports each comprising a spanning member configured to span between first and second wall elements to define a concrete receiving cavity therebetween;
wherein the supports comprise at least one retaining member associated with the spanning member, the at least one retaining member being configured to retain a portion of the fire suppression material relative to the support such that said portion of fire suppression material may form at least a portion of at least one of said first and second wall elements;
retaining at least one portion of fire suppression material via the at least one retaining member; and
filling the concrete receiving cavity to form a wall or portion thereof having the at least one portion of fire suppression material,
and optionally comprising the step of forming at least a portion of the first and second wall elements from wall forming panels such as Expanded Polystyrene (EPS) panels which are attachable to the support.
